(19) United States
(12) Patent Application Publication
(10) Pub. No.: US 2004/0104646 A1
(43) Pub. Date: Jun. 3, 2004

(54) Hinged front gate assembly for a product vending machine

(76) Inventors: Paul Hayward Kelly, Aiken, SC (US); Joshua Robert Powell, Aiken, SC (US); Edmund Scott Richardson, Simpsonvill, SC (US); John T. Samson, Aiken, SC (US); Michael E. Stevens, Coon Rapids, MN (US)

Correspondence Address: DIEDERIKS & WHITELAW, PLC, 12471 Dillingham Square, #301, Woodbridge, VA, 22192, US

(21) Appl. No.: 10/678,187

(22) Filed: Oct. 6, 2003

Related U.S. Application Data
(60) Provisional application No. 60/415,746, filed on Oct. 4, 2002.

(51) Int. Cl. A47F 1/00; B65G 1/16

(52) U.S. Cl. 312/42

(57) ABSTRACT

A hinged front gate assembly includes a plurality of wire retaining elements pivotally secured across a vending machine through a plurality of hinge units for movement between a product retention position and a product loading position through a swing radius defined by the hinge units. When the front gate is shifted to the product retention position, the retaining elements can impinge upon and shift product containers into proper alignment. The front gate assembly can be automatically shifted through closure of a main door, with the door either directly engaging cammed hinges of the front gate assembly or indirectly through a gate pusher attached to the door.

### CROSS-REFERENCE TO RELATED APPLICATIONS

The present application claims benefit of U.S. Provisional Patent Application Serial No. 06/415,746 entitled “HINGED FRONT GATE ASSEMBLY FOR A PRODUCT VENDING MACHINE” filed on Oct. 4, 2002.

### BACKGROUND OF THE INVENTION

1. Field of the Invention

The present invention pertains to the art of vending machines and, more specifically, to a hinged front gate assembly for a product vending machine.

2. Discussion of the Prior Art

It is commonly known to employ vending machines in the selective dispensing of a wide range of products, including edible foods, beverages, and other consumer products. In a vending machine, internal column walls are employed to define product storage magazines or zones. More specifically, a series of column walls are maintained at spaced positions within a vending cabinet and serve as partitions to contain, separate, and support stacks of product to be dispensed. Typically, when loading a vending machine, a locked main door is first opened to expose the various storage zones. However, prior to accessing these storage zones or stacks for loading purposes, product retainer bars or the like must be removed or otherwise manually shifted to positions that provide unobstructed access to the storage zones. In prior art arrangements, the retainer bars are typically nested in the product stacks which limits access to the various column openings. After product loading, the retainer structure is manually shifted back to an operating position.

These product retaining arrangements are generally referred to as front gates. A front gate is utilized for various purposes, particularly establishing product spacing and retention. For this purpose, the front gate must be properly, manually repositioned after loading to enable proper product dispensing. If the front gate is not properly repositioned, it is susceptible to being damaged upon closing of the main door which, in turn, can negatively impact the overall reliability of further vending operations. Regardless of the existence of various styles of front gate arrangements, there still exists a need in the art for an improved front gate arrangement which effectively maintains desired product positioning, can be more easily repositioned for product loading, provides enhanced access to product stack zones, and is designed to assure that an effective operating position will be assumed following a product loading operation.

### SUMMARY OF THE INVENTION

The present invention is directed to a hinged front gate assembly for a vending machine. More specifically, in accordance with a preferred embodiment of the invention, a vending machine front gate assembly is formed from a wire retainer structure which is attached to at least two bar supports through a plurality of hinge units. The entire wire retainer structure can be manually shifted from an operating or product retention position, wherein a plurality of individual wire retainer elements of the structure extend substantially vertically in front of columns of stored products and within the product columns to assure proper product retention, to a loading position, wherein each of the retainer elements is pivoted outward to be in line with a respective column wall. In this manner, full access to the product stack zone is provided.

In accordance with the invention, the hinged mounting arrangement establishes a swing radius that effectively eliminates the potential that certain products may not be fully inserted within a given product stack during loading. More specifically, the shifting of the overall gate structure in this manner allows the gate to impinge on the ends of the products stored in the respective column stacks. With this arrangement, when the front gate is repositioned following a loading operation, the products are forced to shift into appropriate, aligned positions.

In accordance with the invention, the front gate is automatically pivoted to its operating position upon closing of the main door for the vending machine. In one preferred form of the invention, the various hinge units also define camming surfaces which are adapted to be engaged by an inner panel of the main door to force the front gate to automatically pivot upon closing of the door. In one preferred form of the invention, the gate is hinged to vertically spaced, front cross bar supports through four hinge units, each of which becomes engaged with the inner door panel so as to automatically shift upon closing of the main door.

In accordance with another embodiment of the invention, a gate pusher member is mounted on the inner panel of the main door and engages a portion of the gate to automatically pivot the gate closed upon closing of the door. In a still further embodiment of the invention, a device can be provided to shift the gate to the open or loading position automatically upon opening of the main door. The device can take various forms, including one or more biasing springs, or an element attached to the inner door panel which actually abuts the gate upon opening of the main door.

With this construction, the front gate extends into the various product stacks to provide enhanced product retention. In addition, the front gate can be pivoted to a loading position which is outside the product stacks and aligned with column walls, thereby providing unobstructed access to the loading areas. Furthermore, the front gate is assured of being properly repositioned for product retention after a loading operation due to the interaction with the main door.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a front elevational view of a vending machine constructed in accordance with the present invention illustrated with the front gate assembly removed;

FIG. 2 is a front view of inner vending machine structure including the front gate assembly of the invention constructed in accordance with a first embodiment of the invention shown in a closed or product retention position;

FIG. 3 is a front view of the vending machine structure of FIG. 1, illustrating the front gate assembly of the invention in a closed or product retention position;

FIG. 4 is an enlarged view of a portion of the front gate assembly in the product retention position of FIG. 3;

FIG. 5 is a front view similar to that of FIG. 3, but illustrating the front gate assembly in an open or product loading position;

FIG. 6 is an enlarged view of a portion of the front gate assembly n the product loading position of FIG. 5;

FIG. 7 is a top view of the vending machine showing both the front gate of a second embodiment and the vending machine door closed;

FIG. 8 is a top view of the vending machine, similar to that of FIG. 7, with the front gate fully open and the vending machine door partially open;

FIG. 9 is a top view illustrating the front gate fully open, with a product illustrated in an undesired, partially loaded position;

FIG. 10 is a top view, similar to that of FIG. 9, illustrating the automatic repositioning of the partially loaded product upon closing of the front gate; and

FIG. 11 is a perspective view of an inner portion of a vending machine constructed in accordance with a third embodiment wherein the front gate is adapted to be automatically closed through the use of a gate pusher attached to the back of the main door.

### DETAILED DESCRIPTION OF THE PREFERRED EMBODIMENTS

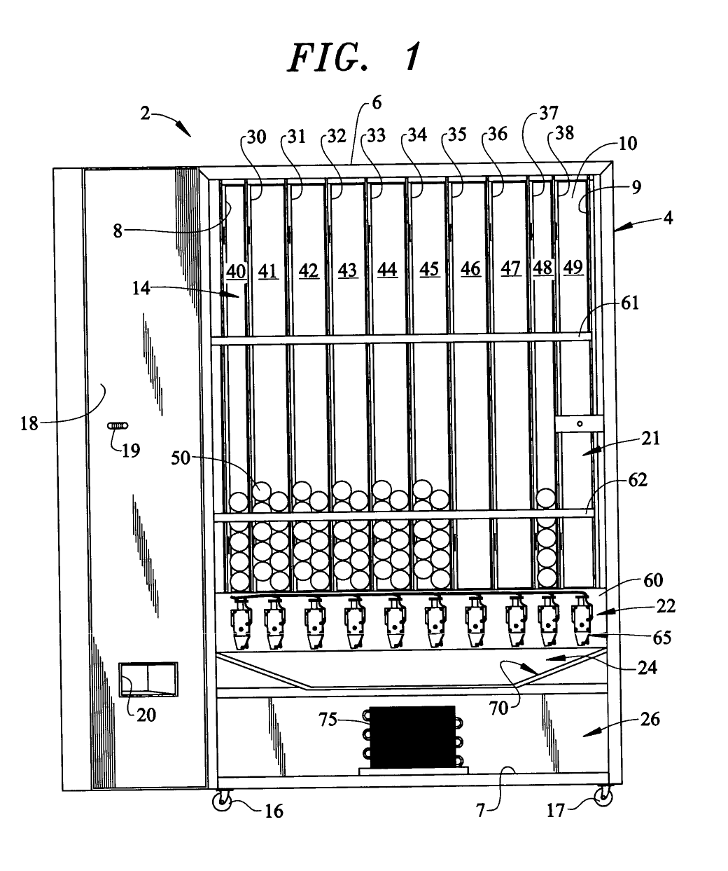

With initial reference to FIG. 1, a vending machine 2 includes a cabinet frame 4 having top, bottom, side and rear walls 6-10 that collectively define a central cavity 14. In a manner known in the art, a first pair of wheels or casters 16 and 17 are secured to a front edge portion of bottom wall 7 to facilitate the positioning of vending machine 2. Of course it should be realized that a second pair of wheels (not shown) are also arranged on a rear portion of bottom wall 7. A door 18 is pivotally mounted to cabinet frame 4 to selectively enable access to central cavity 14 in order to load various product containers or other commodities into vending machine 2. Door 18 is provided with a locking mechanism, shown in the form of a threaded rod 19, to retain door 18 in a closed position so as to prevent pilfering of the commodities from central cavity 14. Door 18 is also provided with an opening 20 to enable a consumer to remove a vended product container or other commodity from vending machine 2.

Central cavity 14 includes a storage section 21, a dispensing section 22, a delivery section 24 and a lower section 26. Storage section 21 is provided to hold products in escrow until a vending operation is performed. Towards that end, storage section 21 is provided with a plurality of vertically extending column walls 30-39 which, together with side walls 8 and 9 form a plurality of column or stack areas 40-49. In the embodiment shown in FIG. 1, stack areas 40-49 constitute single stack columns. However, it should be understood that the present invention also encompasses vending machines having multi-stack columns. In any event, stack areas 40-49 are partitioned by walls 32-36 to contain, separate and support a plurality of generally cylindrical containers 50 which, in the embodiment shown, constitute soda cans.

As further shown in FIG. 1, dispensing section 22 is provided with a frontal support wall or plate 60, cross-braces 61 and 62, a top plate 63 and a rear support plate 64. As shown, a plurality of vend motors, one of which is indicated at 65, are arranged on frontal support wall 60. As will be discussed more fully below, a plurality of cradles (not shown) are arranged behind frontal support wall 60. Actually, each column or stack area 40-49 is provided with an associated cradle (not shown) that is operated through a respective one of the plurality of vend motors 65. Upon selection of a particular product container 50 or other commodity, one of the plurality of vend motors 65 is activated to rotate a respective cradle causing a product container 50, corresponding to the selected product, to emerge from vending machine 2. That is, product container 50 is transported to a product delivery chute 70 provided in delivery section 24 which is exposed to opening 20 in door 18. In order to maintain containers 50 in a refrigerated state, lower section 26 is provided with a cooling system 75. In general, the above description is provided for the sake of completeness and to enable a better understanding of the invention.

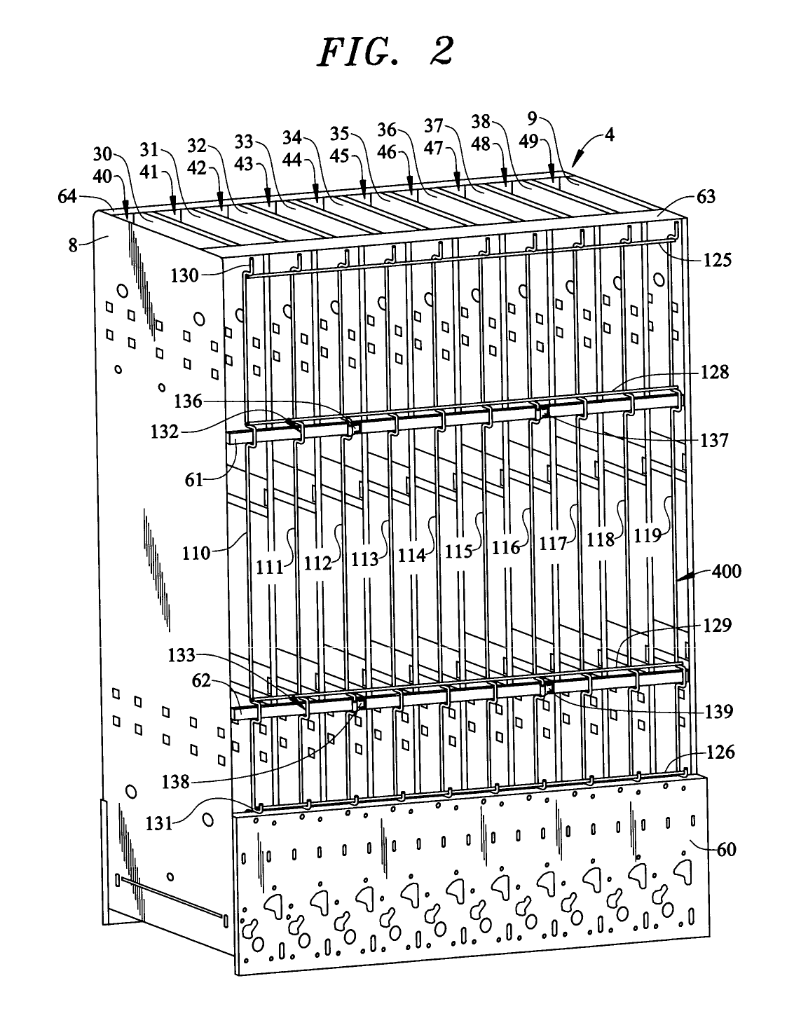

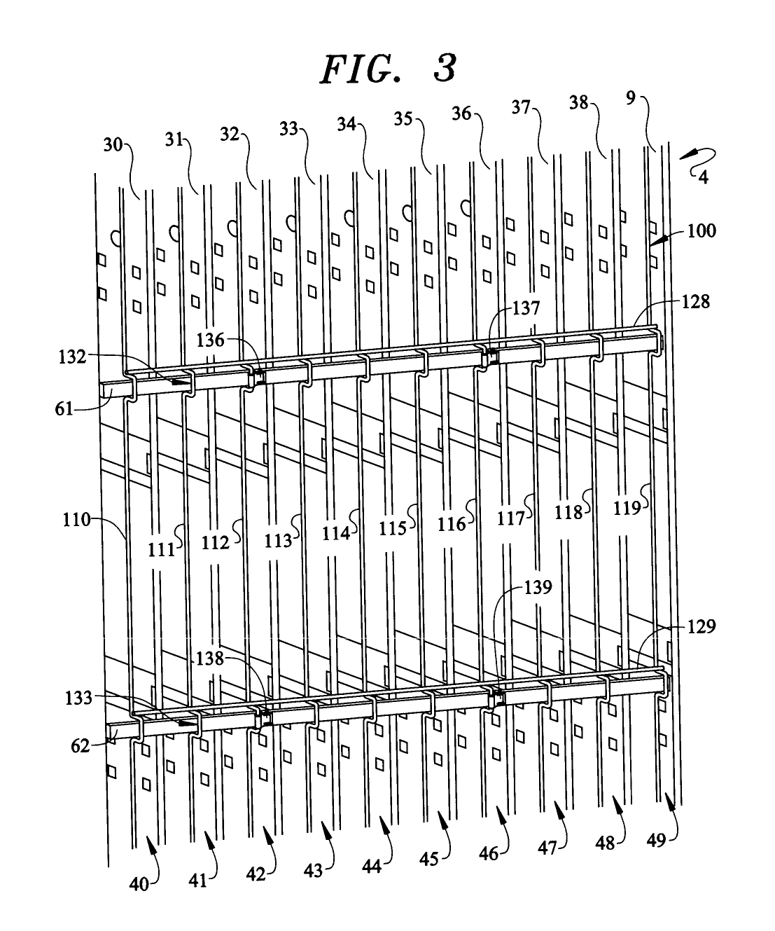

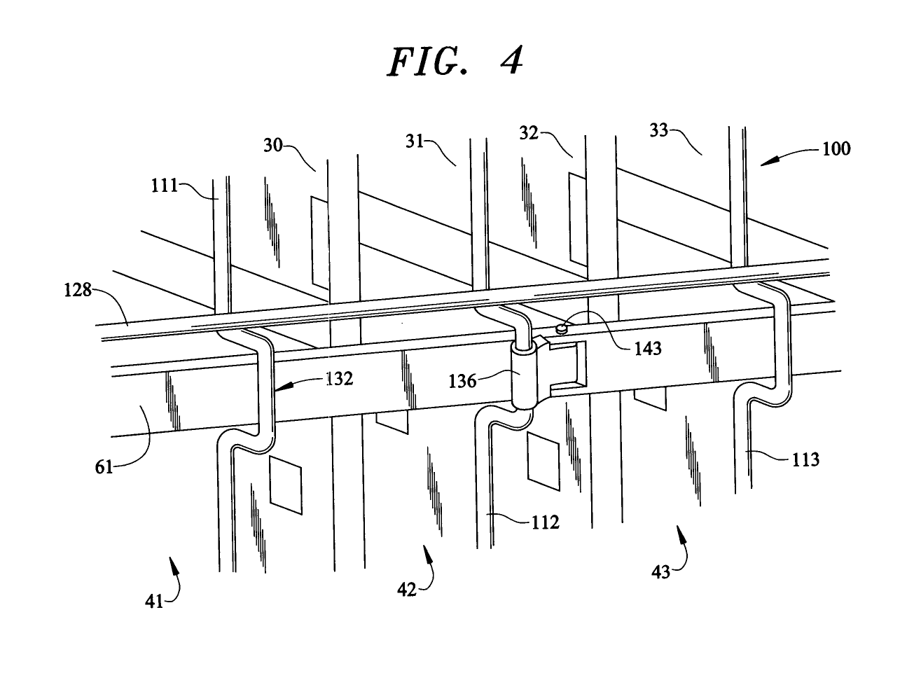

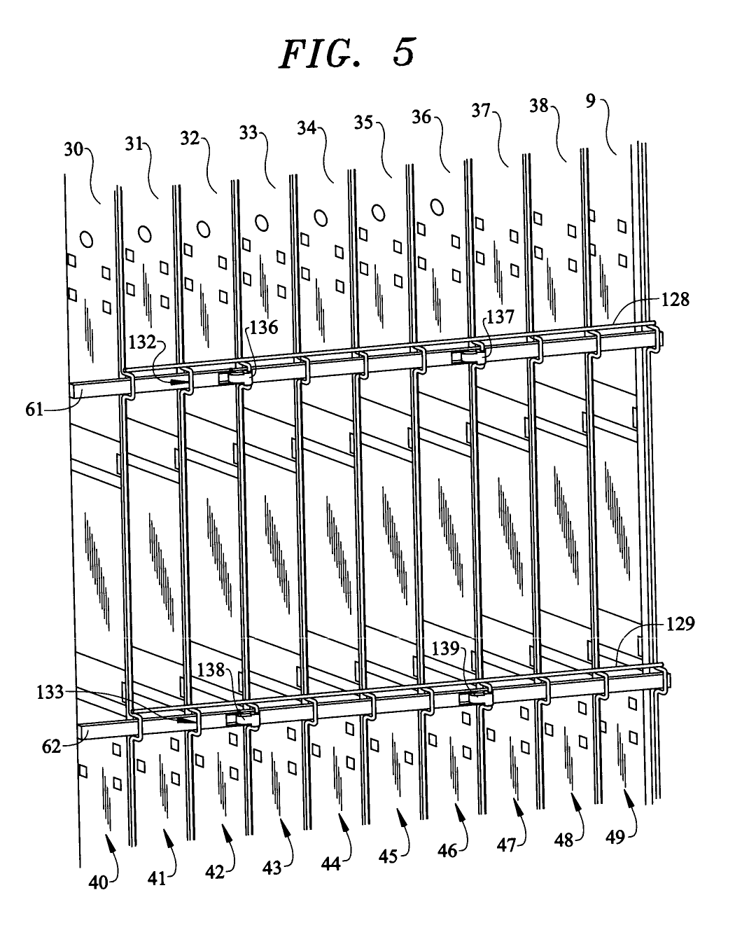

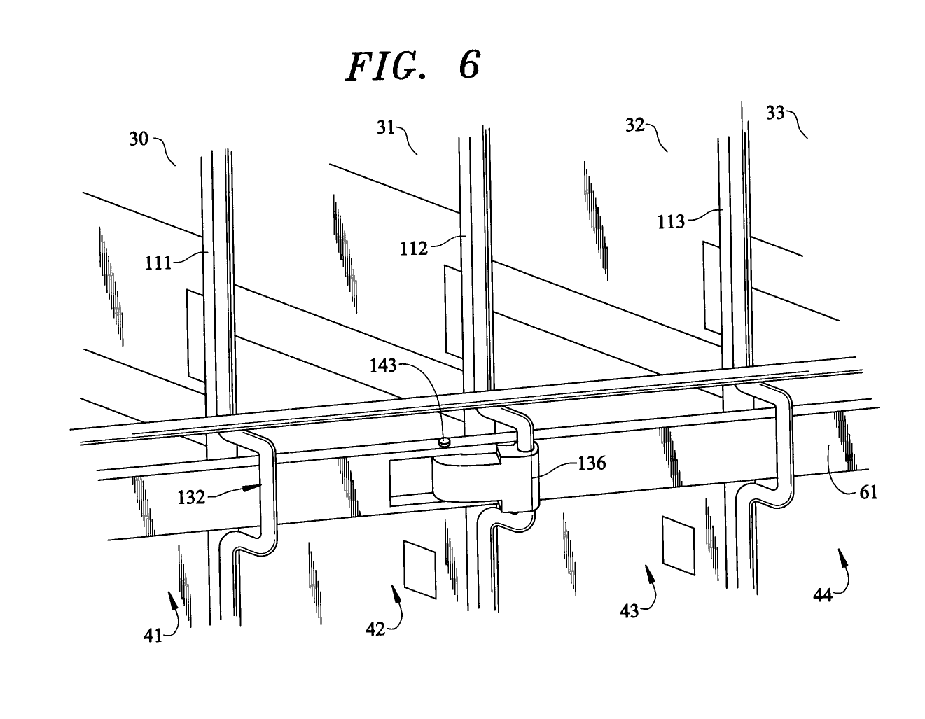

With particular reference to FIG. 2, the present invention is particularly directed to a hinged front gate assembly 100 that extends across central cavity 14. Front gate assembly 100 includes a plurality of wire retaining elements 110-119 that extend substantially vertically between top plate 63 and frontal support wall 60 in front of stack areas 40-49 respectively. Retaining elements 110-119 are interconnected through upper and lower wire cross members 125 and 126, as well as intermediate cross members 128 and 129. In accordance with a preferred form of the invention, retaining elements 110-119 partially extend into each of stack areas 40-49 which, as will be discussed more fully below, aid in aligning product containers 50. Toward that end, wire retaining elements 110-119 are provided with upper and lower offset portions 130 and 131, as well as intermediate U-shaped bend portions 132 and 133. Bend portions 132 and 133 are sized so as to fit over cross braces 61 and 62. Actually, front gate assembly 100 is pivotally mounted to cross braces 61 and 62 through a plurality of hinge units 136-139, each of which includes an associated hinge pin 143 (see FIGS. 4 and 6), that establish a swing radius enabling front gate assembly 100 to move from a first or product retention position represented in FIGS. 2-4 to a second or product loading position represented in FIGS. 5 and 6.

When placed in the product retention position of FIGS. 2-4, front gate assembly 100 maintains an alignment of product containers 50 or other commodities within stack areas 40-49. That is, as each wire retaining element 110-119 partially projects into a respective one of stack areas 40-49, product containers 50 will be assured of being aligned fore-to-aft in stack areas 40-49 to aid in the proper dispensing of product containers 50 from vending machine 2. However, when front gate 100 is in the product retention position, it is impossible to load or replenish the supply of product containers 50 within stack areas 40-49. Therefore, in accordance with the present invention, when it becomes necessary to load product containers 50 into vending machine 2, front gate assembly 100 is manually shifted from the first or product retention position of FIGS. 2-4 wherein wire retaining elements 110-119 extend substantiality vertically in front of stack areas 40-49 to the second or product loading position of FIGS. 5 and 6 wherein wire retaining elements 110-119 are shifted to positions aligned with column walls 30-38 and side wall 9.

More specifically, FIGS. 5 and 6 show front gate assembly 100 in the product loading position. That is, front gate assembly 100 has been shifted from the position of FIGS. 2-4 about a swing radius established by hinge units 136-139 in order to expose stack areas 40-49 so as to enable a service person to replenish a supply of product containers 50 within vending machine 2. Once product containers 50 have been replenished, hinged front gate assembly 100 is shifted back to the product retention position. If any product containers 50 stick partially out of a respective stack area 40-49 upon loading, a respective retaining element 110-119 will impinge upon the ends of product containers 50 thereby forcing product containers 50 to shift rearward into proper alignment.

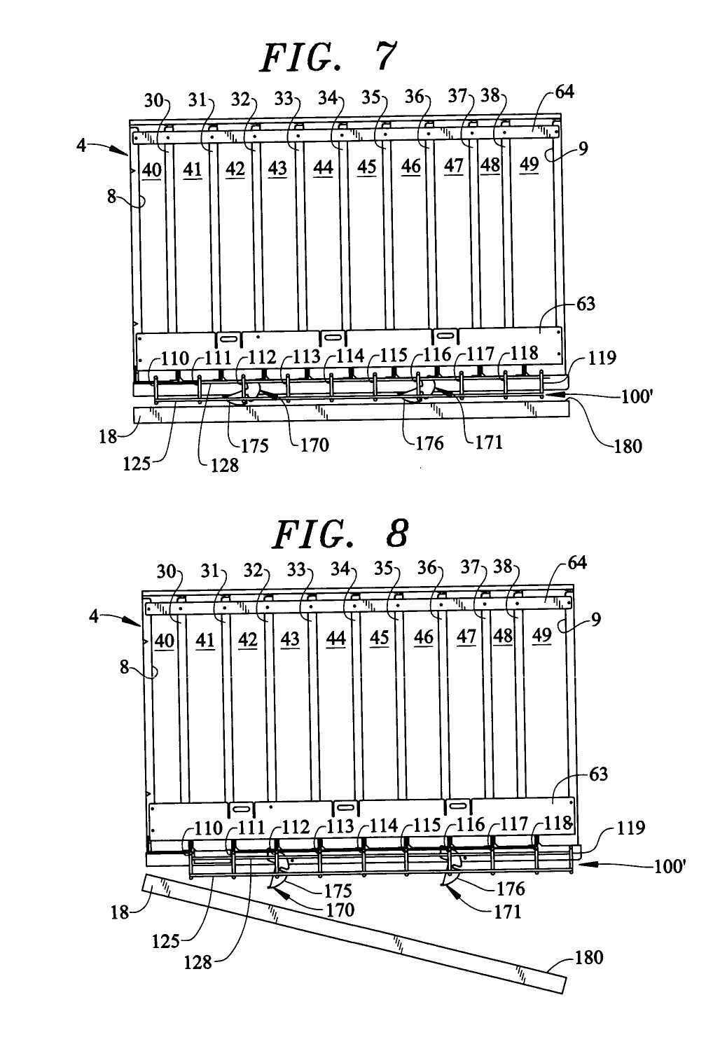

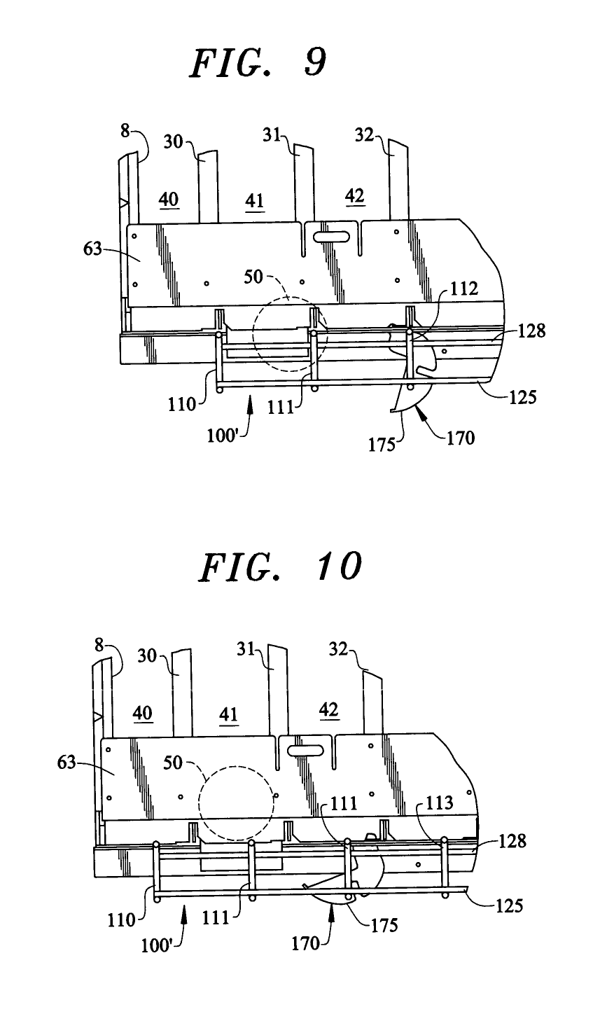

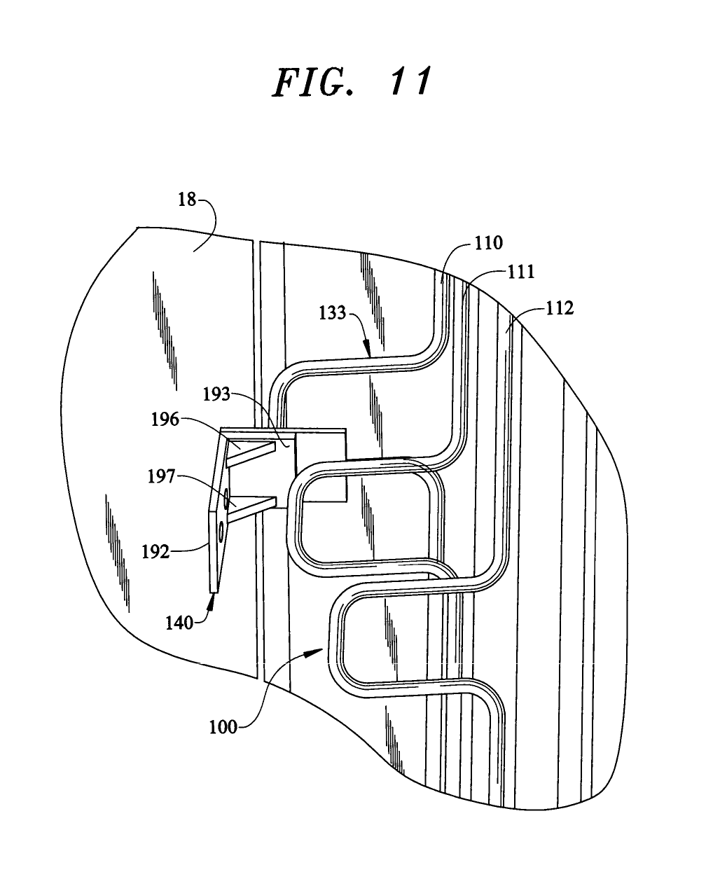

In the embodiment above, hinged front gate assembly 100 is manually shifted from the product loading position to the product retention position. In accordance with a second embodiment of the present invention, a hinged front gate assembly 100′ is automatically shifted from the loading position to the retention position upon closing door 18. Referring to FIGS. 7 and 8, retaining elements 110-119 of hinged front gate assembly 100′ are pivotally mounted to frontal supports 61 and 62 through a plurality of enlarged hinges, two of which are indicated at 170 and 171. Hinges 170 and 171 are provided with cam surfaces 175 and 176 configured to engage with an inner surface 180 of door 18. That is, in accordance with this embodiment, after replenishing the supply of product containers 50 within vending machine 2, the service person need only close door 18 in order to shift front gate assembly 100′ into the product retention position. More specifically, as door 18 moves toward the closed position, inner surface 180 of door 18 engages upon cam surfaces 175 and 176 causing hinges 170 and 171 to automatically shift front gate assembly 100 about a swing radius into the product retention position. Again, front gate assembly 100 will impinge upon end portions of product containers 50 not properly positioned within stack areas 40-49 so as to force proper alignment of the product containers 50 as presented in comparing FIGS. 9 and 10.

In accordance with a third embodiment of the present invention as shown in FIG. 11, hinged front gate assembly 100 is automatically shifted from the loading position to the product retention position through a gate pusher 190 which is fixed to door 18. That is, as door 18 is closed, one or more gate pushers 190 engages with a respective U-shaped bend portion 132, 133 causing front gate assembly 100 to automatically shift about the swing axis into the product retention position. In a manner analogous to that described above with respect to the embodiments described above, as frontal gate assembly 100 is shifted into the product retention position, wire retaining elements 110-119 impinge upon the ends of product containers 50 forcing a rearward shift so as to align product containers 50 within respective ones of stack areas 40-49. In any event, gate pusher 190 includes a first plate 192 which is secured to inner surface 180 of door 18 and leads to a second plate 193 that projects substantially perpendicularly from first plate 192. First and second plates 192 and 193 are joined a pair of support gussets 196 and 197 that prevent second support surface 193 from deflecting when shifting front gate assembly 100 into the product retention position.

Based on the above, it should be apparent that the invention enables either manual or automatic shifting of the front gate assembly in a smooth manner so as to prevent damage to product containers within the vending machine. In any case, the potential for creating a jam within a stack area due to a damaged or misaligned product container is avoided. Although described with reference to preferred embodiments of the present invention, it should be readily apparent to one of ordinary skill in the art that various changes and/or modifications can be made to the invention without departing from the spirit thereof. For instance, while the front gate assembly in one embodiment is shown to include four automatically actuated hinges, additional or fewer hinges would also be acceptable. In general, the invention is only intended to be limited to the scope of the following claims.

I/WE claim:

1. A vending machine comprising:
a cabinet frame including top, bottom, rear and opposing side walls that collectively define a central cavity;
a plurality of column walls defining a plurality of stack areas for receiving and storing product containers;
a door pivotally mounted to the cabinet frame, said door being adapted to selectively close the central cavity; and
a front gate assembly pivotally mounted relative to the column walls, said front gate assembly including a plurality of retainer elements operatively connected to the column walls through a plurality of hinge units, said hinge units establishing a swing radius enabling the plurality of retainer elements to travel along an arcuate path from a first, product retention position to a second, product loading position wherein, in said first position, the plurality of retainer elements extend longitudinally between respective ones of said plurality of column walls to retain product containers in the stack areas and, in said second position, said plurality of retainer elements are generally aligned with respective ones of the column walls thereby enabling product containers to be readily loaded into the plurality of stack areas.

2. The vending machine according to claim 1, further comprising: means for automatically shifting the front gate assembly from the second position to the first position.

3. The vending machine according to claim 2, wherein said shifting means is constituted by at least one cam surface provided along at least one of the plurality of hinge units, said at least one cam surface being adapted to be engaged upon closing of the door.

4. The vending machine according to claim 2, wherein said shifting means is constituted by a gate pusher member secured to the door, said gate pusher member being adapted to engage the front gate assembly upon closing of the door.

5. The vending machine according to claim 1, wherein said front gate assembly includes means for automatically positioning a product container in the stack area.

6. The vending machine according to claim 5, wherein the positioning means is constituted by portions of the plurality of retainer elements traveling along the arcuate path.

7. The vending machine according to claim 1, wherein the front gate assembly includes first and second cross bars, said first and second cross bars extending across and interconnecting the plurality of column walls.

8. The vending machine according to claim 1, further comprising: first and second cross braces extending across and interconnecting the plurality of column walls, said plurality of retainer elements being pivotally secured to the first and second cross braces through the plurality of hinge units.

9. The vending machine according to claim 8, wherein said plurality of hinge units include at least two hinge members pivotally attached to each of the first and second cross braces.

10. The vending machine according to claim 8, wherein each of the first and second cross braces includes at least one slot, wherein a respective one of the plurality of hinge units partially extends into the at least one slot.

11. The vending machine according to claim 8, wherein each of the plurality of retainer elements includes first and second U-shaped bend portions at the first and second cross braces

12. The vending machine according to claim 11, wherein said first and second U-shaped bend portions recess a majority of each of the plurality of retainer elements within respective ones of the plurality of stack areas when the front gate assembly is in the second position.

13. The vending machine according to claim 1, wherein the plurality of retainer elements are formed from wire.

14. A method of loading product containers into a plurality of stack areas defined by laterally spaced column walls arranged within a vending machine comprising:
opening a door to provide access to the plurality of stack areas;
pivoting a front gate assembly having a plurality of retainer elements from a first position, wherein the plurality of retainer elements extend between respective ones of the plurality of stack areas, to a second position, wherein the plurality of retainer elements are generally aligned with respective ones of the column walls, said plurality of retainer elements traveling along an arcuate path established by a plurality of hinge units when traveling from the first position to the second position;
loading product containers into the stack areas; and
pivoting the front gate assembly from the second position to the first position.

15. The method of claim 14, further comprising: engaging the front gate assembly upon closing of the door to automatically pivot the plurality of retainer elements from the second position to the first position.

16. The method of claim 15, wherein pivoting the front gate assembly from the second position to the first position includes abutting a cam member provided on at least one of the plurality of hinge units with an inner surface of the door.

17. The method of claim 15, wherein pivoting the front gate assembly from the second position to the first position includes abutting the front gate assembly with a gate member provided on an inner surface of the door.

18. The method of claim 14, wherein pivoting the front gate assembly includes manually moving the plurality of retainer elements.

19. The method of claim 14, further comprising: automatically repositioning product containers in respective ones of the plurality of stack areas upon pivoting of the front gate assembly from the second position to the first position.
